(19) United States
(12) Patent Application Publication
(10) Pub. No.: US 2025/0091806 A1
(43) Pub. Date: Mar. 20, 2025

(54) TRAVELING SYSTEM, TRAVELING METHOD, AND RECORDING MEDIUM STORING TRAVELING PROGRAM

(71) Applicant: SHARP KABUSHIKI KAISHA, Sakai City (JP)

(72) Inventors: THINH NGUYENQUANG, Sakai City (JP); AKIHIRO YAMAKAWA, Sakai City (JP); HIROSHI YAMAUCHI, Sakai City (JP); MASAHIRO SAKAKIBARA, Sakai City (JP); KAZUSHI KUWAHATA, Sakai City (JP); HIROKI OSAWA, Sakai City (JP)

(21) Appl. No.: 18/829,773

(22) Filed: Sep. 10, 2024

(30) Foreign Application Priority Data
Sep. 14, 2023 (JP) 2023-149141

(51) Int. Cl. B65G 1/137; G05D 1/244; G05D 1/646; G05D 105/20; G05D 107/70

(52) U.S. Cl. CPC B65G 1/1373; B65G 1/1371; G05D 1/2446; G05D 1/646; B65G 2203/0216; B65G 2203/0233; G05D 2105/20; G05D 2107/70

(57) ABSTRACT

A first acquisition processing unit acquires tag status information including information indicating whether a transport target is present at a position corresponding to a tag and information indicating whether an automatic traveling device is present at the position corresponding to the tag. A second acquisition processing unit acquires AGV status information indicating whether the automatic traveling device is transporting the transport target. A determination processing unit determines whether the automatic traveling device is capable of traveling through the position corresponding to the tag on the basis of the tag status information and the AGV status information. A generation processing unit generates a travel route of the automatic traveling device on the basis of a determination result of the determination processing unit.

### INCORPORATION BY REFERENCE

This application is based upon and claims the benefit of priority from the corresponding Japanese Patent Application No. 2023-149141 filed on Sep. 14, 2023, the entire contents of which are incorporated herein by reference.

### BACKGROUND

The disclosure relates to a traveling system, a traveling method, and a recording medium storing a traveling program for causing an automatic traveling device to travel.

Known traveling systems include a traveling system that causes an automatic traveling device (automated guided vehicle (AGV), traveling vehicle, or the like) to travel to a target position along a travel route set in advance. For example, there is known a traveling system in which a plurality of shelves for storing articles are stored at predetermined storage positions, and an automatic traveling device travels under a shelf stored at the storage position and lifts and transports the shelf to a target position.

However, in the traveling system in the related art, a region where the plurality of shelves are arranged is set as a region in which entry is prohibited, except when the automatic traveling device enters to pick up (lift up and transport) a shelf to be transported. As a result, there is a problem in that the region where the plurality of shelves are arranged cannot be effectively utilized as a travel route of the automatic traveling device, reducing a traveling efficiency.

### SUMMARY

An object of the disclosure is to provide a traveling system, a traveling method, and a recording medium storing a traveling program capable of improving a traveling efficiency of an automatic traveling device capable of transporting a transport target.

A traveling system according to an aspect of the disclosure is a traveling system that controls traveling of an automatic traveling device that travels while sequentially detecting a plurality of tags arranged on a floor surface and is capable of transporting, to a designated position, a transport target stored at a position corresponding to a storage position designation tag that is part of the plurality of tags. The traveling system includes a first acquisition processing unit, a second acquisition processing unit, a determination processing unit, and a generation processing unit. The first acquisition processing unit acquires storage position designation tag status information including information indicating whether the transport target is present at the position corresponding to the storage position designation tag and information indicating whether the automatic traveling device is present at the position corresponding to the storage position designation tag. The second acquisition processing unit acquires automatic traveling device status information indicating whether the automatic traveling device is transporting the transport target. The determination processing unit determines whether the automatic traveling device is capable of traveling through the position corresponding to the storage position designation tag on the basis of the storage position designation tag status information and the automatic traveling device status information. The generation processing unit generates a travel route of the automatic traveling device on the basis of a determination result of the determination processing unit.

A traveling method according to another aspect of the disclosure is a method for controlling traveling of an automatic traveling device that travels while sequentially detecting a plurality of tags arranged on a floor surface and is capable of transporting, to a designated position, a transport target stored at a position corresponding to a storage position designation tag that is part of the plurality of tags. The traveling method is a method in which one or more processors execute: acquiring storage position designation tag status information including information indicating whether the transport target is present at the position corresponding to the storage position designation tag and information indicating whether the automatic traveling device is present at the position corresponding to the storage position designation tag, acquiring automatic traveling device status information indicating whether the automatic traveling device is transporting the transport target, determining whether the automatic traveling device is capable of traveling through the position corresponding to the storage position designation tag on the basis of the storage position designation tag status information and the automatic traveling device status information, and generating a travel route of the automatic traveling device on the basis of a determination result.

A non-transitory computer-readable recording medium according to another aspect of the disclosure records a program that controls traveling of an automatic traveling device that travels while sequentially detecting a plurality of tags arranged on a floor surface and is capable of transporting, to a designated position, a transport target stored at a position corresponding to a storage position designation tag that is part of the plurality of tags. The traveling program causes one or more processors to acquire storage position designation tag status information including information indicating whether the transport target is present at the position corresponding to the storage position designation tag and information indicating whether the automatic traveling device is present at the position corresponding to the storage position designation tag, acquire automatic traveling device status information indicating whether the automatic traveling device is transporting the transport target, determine whether the automatic traveling device is capable of traveling through the position corresponding to the storage position designation tag on the basis of the storage position designation tag status information and the automatic traveling device status information, and generate a travel route of the automatic traveling device on the basis of a determination result.

According to the disclosure, it is possible to provide a traveling system, a traveling method, and a recording medium storing a traveling program capable of improving a traveling efficiency of an automatic traveling device capable of transporting a transport target.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of a traveling system according to an embodiment of the disclosure.

FIG. 2 is a view schematically illustrating a configuration of a facility to which the traveling system according to the embodiment of the disclosure is applied.

FIG. 3 is a view illustrating an arrangement example of storage shelves disposed in the facility to which the traveling system according to the embodiment of the disclosure is applied.

FIG. 4 is a view illustrating a state in which the automatic traveling device according to the embodiment of the disclosure transports a storage shelf.

FIG. 5 is a view illustrating an example of traveling states of AGVs in the facility to which the traveling system according to the embodiment of the disclosure is applied.

FIG. 6 is a table illustrating an example of tag status information utilized in the traveling system according to the embodiment of the disclosure.

FIG. 7 is a table illustrating an example of AGV status information utilized in the traveling system according to the embodiment of the disclosure.

FIG. 8 is a view illustrating an example of traveling states of AGVs in the facility to which the traveling system according to the embodiment of the disclosure is applied.

FIG. 9 is a correspondence table illustrating whether route generation and travel instructions are possible for the AGVs according to the embodiment of the disclosure.

FIG. 10 is a flowchart illustrating an example of a procedure of traveling processing executed by the traveling system according to the embodiment of the disclosure.

### DETAILED DESCRIPTION

Embodiments of the disclosure will be described below with reference to the drawings for an understanding of the disclosure. Note that the following embodiments are specific examples of the disclosure, and do not limit the technical scope of the disclosure.

### Traveling System 10

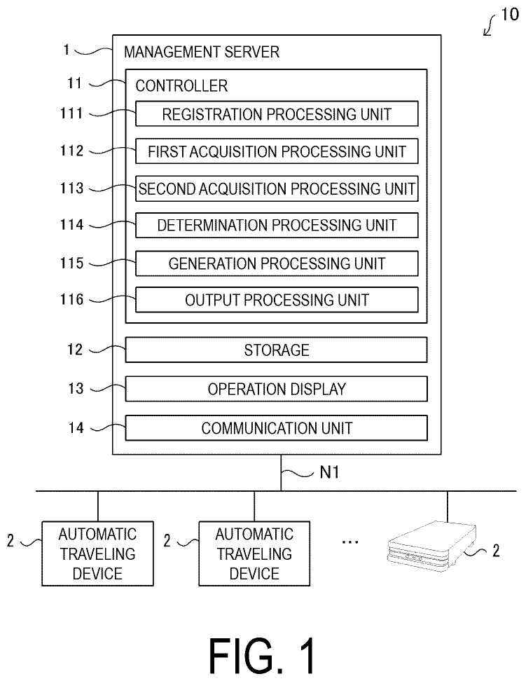

As illustrated in FIG. 1, a traveling system 10 according to an embodiment of the disclosure includes a management server 1 and an automatic traveling device 2 (also referred to as an automated guided vehicle (AGV) or an unmanned transport device). The management server 1 and the automatic traveling device 2 can communicate with each other via a communication network N1 such as a wireless local area network (LAN).

The traveling system 10 is a traveling system capable of guiding the automatic traveling device 2 by detecting a plurality of tags arranged on a floor surface. For example, the automatic traveling device 2 travels along a travel route set in advance while detecting a two dimensional code (or a marker or the like) arranged on (adhered to) the floor surface. The traveling system 10 includes one or more automatic traveling devices 2.

Further, for example, in a travel area provided with a plurality of paths on which the automatic traveling device 2 can travel, the traveling system 10 designates, among the plurality of paths, a path on which the automatic traveling device 2 should travel as a travel route, and causes the automatic traveling device 2 to transport a transport target from a storage position to a target position. The traveling system 10 is applied to, for example, a facility such as a factory or a warehouse that stores products. For example, the traveling system 10, upon receipt of an order for a product from a customer (customer terminal), outputs travel instructions (a transport request) to the automatic traveling device 2. The automatic traveling device 2, upon acquisition of the travel instructions, moves to the storage position (storage shelf) of the product, couples the storage shelf, and transports the storage shelf to a picking area. In the picking area, a worker takes out the target product (ordered product) from the storage shelf and transports the product to a shipping area. The customer can utilize an information processing device (customer terminal) such as a personal computer or a smartphone to access a website (order page) operated by an order server (not illustrated) and place an order for a product.

The order server is capable of receiving an order of the product from each of a plurality of customer terminals and collects and outputs the various order information received to the management server 1. The management server 1 manages the operation of each of the plurality of automatic traveling devices 2, and outputs travel instructions to each automatic traveling device 2 on the basis of the order information. The automatic traveling device 2 autonomously travels on a travel route set in advance on the basis of the travel instructions, and moves a storage shelf storing the product included in the order information to the picking area.

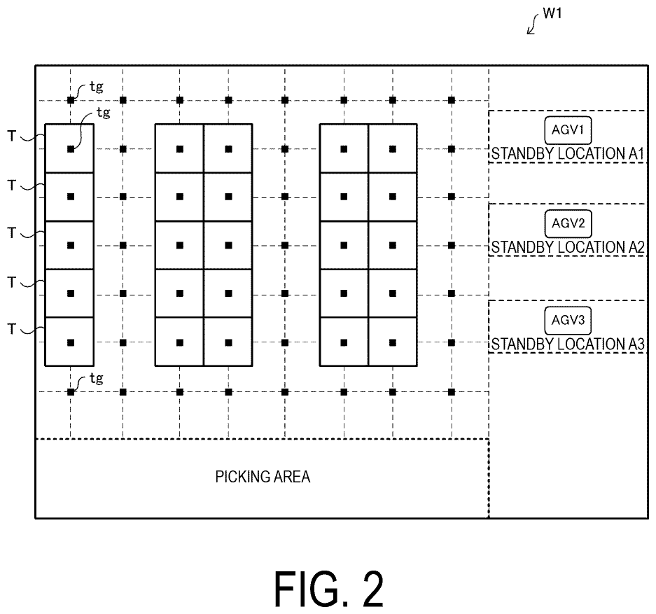

FIG. 2 illustrates an example of a facility W1 to which the traveling system 10 is applied. In the facility W1 illustrated in FIG. 2, a plurality of storage shelves T (transport targets) for storing products are arranged. Twenty-five storage shelves T are illustrated in FIG. 2. Further, in the facility W1, standby locations for the automatic traveling devices 2 are set. For example, in the facility W1, a standby location A1 where an AGV1 (automatic traveling device 2) waits, a standby location A2 where an AGV2 (automatic traveling device 2) waits, and a standby location A3 where an AGV3 (automatic traveling device 2) waits are set. Each of the automatic traveling devices 2 waits at a predetermined standby location when travel instructions are not received from the management server 1.

In the facility W1, tags tg are arranged on a floor surface of a travelable region of the automatic traveling device 2. The tag tg is constituted by a two dimensional code, a marker, a radio frequency identification (RFID), or the like. A region in which the tag tg is arranged is a travelable region of the automatic traveling device 2. As illustrated in FIG. 2, the tags tg are arranged at equal intervals at positions where the storage shelves T are arranged and in paths between the storage shelves T. A plurality of the tags tg are also arranged at equal intervals in areas (passage areas) where the storage shelves T are not arranged. The tag tg arranged in an area (storage area) where the storage shelf T is arranged corresponds to a storage position designation tag of the disclosure.

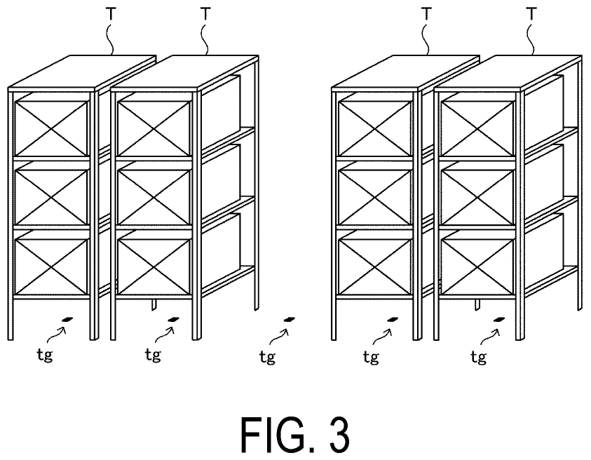

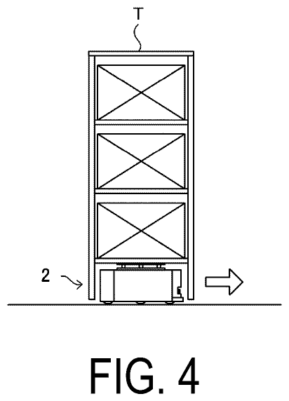

For example, as illustrated in FIG. 3, the tag tg is arranged at a center position of the storage shelf T and a center position between the storage shelves T. The storage shelf T includes a plurality of storage shelves (three storage shelves in FIG. 3) on which products are placed, and a space into which the automatic traveling device 2 can enter is formed in a lowermost stage. As illustrated in FIG. 4, the automatic traveling device 2, upon reaching the storage shelf T storing a target product, can travel under the storage shelf T, couple (lift) the storage shelf T by a coupling portion, and move together with the storage shelf T. The automatic traveling device 2 of the present embodiment has a configuration in which the storage shelf T is lifted and moved. However, as another embodiment, in a case in which the storage shelf T includes wheels, the automatic traveling device 2 may be configured to tow the storage shelf T.

With the space being formed at the lowermost stage of the storage shelf T, the automatic traveling device 2 can pass under the storage shelf T. That is, in the present embodiment, not only regions where the storage shelves T are not arranged (regions between the storage shelves T) but also regions where the storage shelves T are arranged can be utilized as paths on which the automatic traveling device 2 can travel.

Each automatic traveling device 2, upon acquisition of travel instructions from the management server 1, moves from the standby location to the storage shelf T that stores the ordered product. For example, the AGV1, upon acquisition of travel instructions including the product of the storage shelf T in the order information from the management server 1, moves to the position of a storage shelf T1 according to the travel route set in advance, couples (is loaded with) the storage shelf T1, and moves (transports) the storage shelf T1 to the picking area. When the worker takes out the ordered product from the storage shelf T1, the automatic traveling device 2 moves to a predetermined position (storage area) according to the travel route set in advance.

That is, the traveling system 10 controls the traveling of the automatic traveling device 2 that travels while sequentially detecting the plurality of tags tg arranged on the floor surface and is capable of transporting, to a designated position (picking area), the storage shelf T stored at the position corresponding to the tag tg (storage position destination tag), which is part of the plurality of tags tg. Each storage shelf T is moved between the storage area and the picking area by the automatic traveling devices 2. A position of each storage shelf T in the storage area is not fixed, and is managed to be movable to a desired position. Note that the position of each storage shelf T in the storage area may be fixed.

In the present embodiment, the traveling system 10 corresponds to a traveling system according to the disclosure. However, the traveling system according to the disclosure may be constituted by the management server 1 alone, or may include one or more constituent elements of the management server 1 and the automatic traveling device 2.

### Management Server 1

As illustrated in FIG. 1, the management server 1 is a server including a controller 11, a storage 12, an operation display 13, a communication unit 14, and the like. Note that the management server 1 is not limited to being a single computer, and may be a computer system in which a plurality of computers operate in cooperation with each other. Further, the various types of processing executed by the management server 1 may be distributed and executed by one or more processors.

The communication unit 14 is a communication interface for connecting the management server 1 to the communication network N1 in a wired or wireless manner and executing data communication with one or more automatic traveling devices 2 via the communication network N1 in accordance with a predetermined communication protocol.

The operation display 13 is a user interface including a display such as a liquid crystal display or an organic electroluminescent (EL) display that displays various types of information, and an operation unit such as a mouse, a keyboard, or a touch panel that receives an operation.

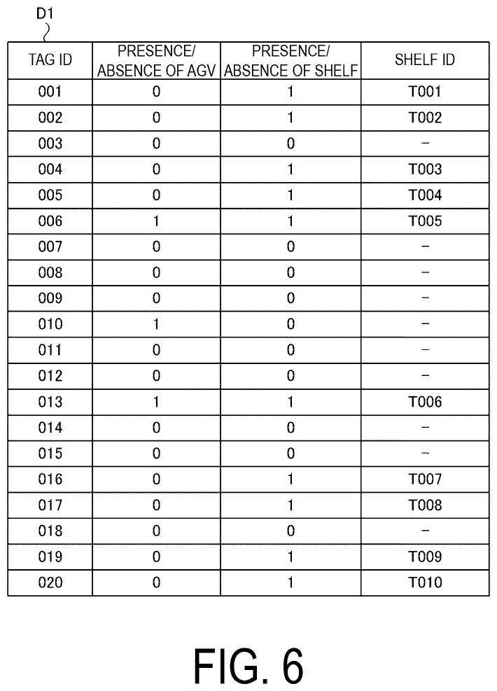

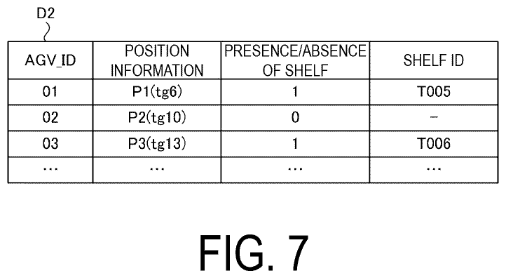

The storage 12 is a non-volatile storage such as a hard disk drive (HDD) or a solid state drive (SSD) that stores various types of information. Specifically, the storage 12 stores tag status information D1 (refer to FIG. 6), AGV status information D2 (refer to FIG. 7), and the like. In the tag status information D1, current status information indicating whether the storage shelf T is present and whether the automatic traveling device 2 (AGV) is present at the position of each tag tg is registered. In the AGV status information D2, current status information indicating the current position of each AGV and whether each AGV is moving the storage shelf T (refer to FIG. 4) is registered.

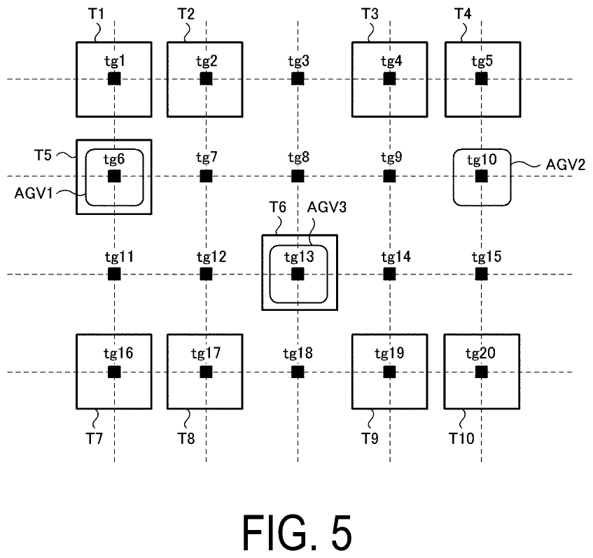

FIG. 5 illustrates the current traveling state of each AGV in the storage area of the facility W1. Here, as an example, 20 tags tg1 to tg20 (storage position designation tags), ten storage shelves T1 to T10, and three storage shelves AGV1 to AGV3 are illustrated.

As illustrated in FIG. 6, the tag status information D1 includes, for each tag tg, corresponding information such as “tag ID,” “presence/absence of AGV,” “presence/absence of shelf,” and “shelf ID.” The tag ID is identification information of the tag tg, and the tag IDs “001” to “020” correspond to the tags tg1 to tg20, respectively. The presence/absence of AGV is information indicating whether an AGV is present at the position of the tag tg, “0” indicating that an AGV is not present at the position of the tag tg, and “1” indicating that an AGV is present at the position of the tag tg. As illustrated in FIG. 5, the AGV1 is present at the position of the tag tg6, the AGV2 is present at the position of the tag tg10, and the AGV3 is present at the position of the tag tg13, and thus “1” is registered for the presence/absence of AGV for each of the tag IDs “006,” “010,” “013,” and “0” is registered for the presence/absence of AGV for the other tag IDs.

The presence/absence of shelf is information indicating whether the storage shelf T is present at the position of the tag tg, “0” indicating that the storage shelf T is not present at the position of the tag tg, and “1” indicating that the storage shelf T is present at the position of the tag tg. As illustrated in FIG. 5, the storage shelf T1 is present at the position of the tag tg1, the storage shelf T2 is present at the position of the tag tg2, the storage shelf T3 is present at the position of the tag tg4, the storage shelf T4 is present at the position of the tag tg5, the storage shelf T5 is present at the position of the tag tg6, the storage shelf T6 is present at the position of the tag tg13, the storage shelf T7 is present at the position of the tag tg16, the storage shelf T8 is present at the position of the tag tg17, the storage shelf T9 is present at the position of the tag tg19, and the storage shelf T10 is present at the position of the tag tg20. Thus “1” is registered for the presence/absence of shelf for each of the tag IDs “001,” “002,” “004,” “005,” “006,” “013,” “016,” “017,” “019,” and “020” and “0” is registered for the presence/absence of shelf for the other tag IDs.

The shelf ID is identification information of the storage shelf T, and shelf IDs “T001” to “T010” correspond to the storage shelves T1 to T10, respectively.

The controller 11 acquires information such as a traveling position and the presence/absence of the storage shelf T (whether the storage shelf T is being transported) from each AGV and updates the tag status information D1 in real time.

As illustrated in FIG. 7, the AGV status information D2 includes corresponding information such as “AGV_ID,” “position information,” “presence/absence of shelf,” and “shelf ID” for each AGV. The AGV_ID is identification information of the AGV (automatic traveling device 2), and the AGV_IDs “01” to “03” correspond to the AGV1 to the AGV3, respectively. The position information is information indicating the current position of the AGV and is, for example, coordinate information (X coordinate and Y coordinate) on a coordinate plane of a map corresponding to the facility W1. For example, position information “P1” indicates the current position of the AGV1 and corresponds to the position (coordinates) of the tag tg6. Further, position information “P2” indicates the current position of the AGV2 and corresponds to the position (coordinates) of the tag tg10, and position information “P3” indicates the current position of the AGV3 and corresponds to the position (coordinates) of the tag tg13.

The presence/absence of shelf is information indicating whether the AGV is transporting the storage shelf T (refer to FIG. 4), “0” indicating a state in which the AGV is not transporting the storage shelf T (state in which the AGV is not loaded with or towing the storage shelf T), and “1” indicating a state in which the AGV is transporting the storage shelf T (state in which the AGV is loaded with or towing the storage shelf T). As illustrated in FIG. 5, the AGV1 is transporting the storage shelf T5 and the AGV3 is transporting the storage shelf T6, and thus “1” is registered for the presence/absence of shelf for each of the AGV_IDs “01,” “03.” In contrast, the AGV2 is not transporting the storage shelf T and is traveling alone, and thus “0” is registered for the presence/absence of shelf for the AGV_ID.

The shelf ID is identification information of the storage shelf T, and shelf IDs “T005,” “T006” correspond to the storage shelves T5, T6, respectively.

The controller 11 acquires information such as the traveling position and the presence/absence of the storage shelf T (whether the storage shelf T is being transported) from each AGV and updates the AGV status information D2 in real time.

The storage 12 may store data such as product information, order information, transport information, and map data. The product information includes information related to the products stored in the facility W1. The order information includes information related to the order of the customer. The transport information includes information related to a storage position of the product related to the customer's order. The map data includes arrangement information (coordinate information) of the tags tg arranged on the floor surface of the facility W1.

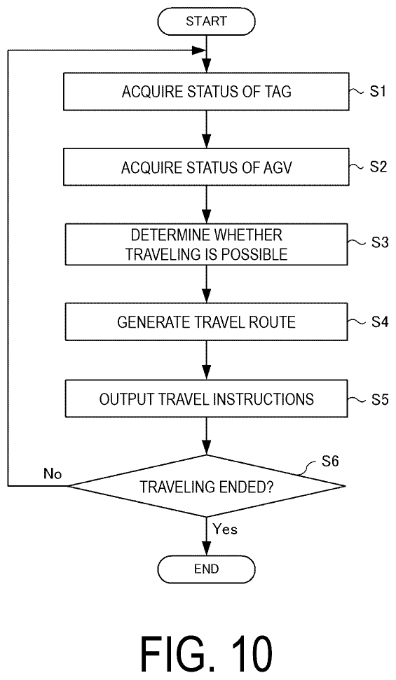

Note that, as another embodiment, some or all of the tag status information D1, the AGV status information D2, the product information, the order information, the transport information, and the map data may be stored in another server accessible from the management server 1 via the network N1. In this case, the controller 11 of the management server 1 may acquire the information from the other server and execute processing such as a traveling processing (refer to FIG. 10) described below.

Further, the storage 12 stores a control program such as a traveling program for causing the controller 11 to execute the traveling processing described below. For example, the traveling program is non-temporarily recorded in a computer-readable recording medium such as a compact disc (CD) or a digital versatile disc (DVD), read by a reading device (not illustrated) such as a CD drive or a DVD drive included in the management server 1, and stored in the storage 12.

The controller 11 includes control devices such as a central processing unit (CPU), a read only memory (ROM), and a random access memory (RAM). The CPU is a processor that executes various types of arithmetic processing. The ROM is non-volatile storage that stores, in advance, control programs such as a basic input/output system (BIOS) and an operating system (OS) for causing the CPU to execute various types of calculation processing. The RAM is a volatile or non-volatile storage that stores various types of information and is used as a temporary storage memory (work area) for the various types of processing executed by the CPU. Then, the controller 11 controls the management server 1 by causing the CPU to execute various types of the control programs stored in advance in the ROM or the storage 12.

Specifically, as illustrated in FIG. 1, the controller 11 includes various types of processors such as a registration processing unit 111, a first acquisition processing unit 112, a second acquisition processing unit 113, a determination processing unit 114, a generation processing unit 115, and an output processing unit 116. Note that the controller 11 functions as the various types of processors by executing various types of processing in accordance with the traveling program using the CPU. Further, some or all of the processors may be constituted by an electronic circuit. Note that the traveling program may be a program for causing a plurality of processors to function as the processors.

The controller 11 receives a shipping request of a product for the automatic traveling device 2. Specifically, the controller 11 receives order information corresponding to an order of a customer. The controller 11, upon receiving the order information, generates transport information.

The registration processing unit 111 registers, for each of the plurality of tags tg, the tag status information D1 (refer to FIG. 6) associating the information related to the presence/absence of the AGV and the presence/absence of the storage shelf T with a tag ID. Further, the registration processing unit 111 registers, for each AGV, the AGV status information D2 (refer to FIG. 7) associating the current position (position information) of the AGV and the information related to the presence/absence of the storage shelf T with the AGV_ID.

The registration processing unit 111 determines, for each tag tg, whether the AGV is present and whether the storage shelf T1 is present at the position of the tag tg on the basis of the arrangement information (coordinate information) of the tags tg and the arrangement information (coordinate information) of the storage shelves T registered in advance and on the basis of the current positions (position information) and information related to the presence/absence of the storage shelf T acquired in real time from each AGV, registers this information as the tag status information D1, determines, for each AGV, the current position of the AGV and whether the AGV is transporting the storage shelf T1, and registers this information as the AGV status information D2. The registration processing unit 111 updates the tag status information D1 and the AGV status information D2 in real time while each AGV is traveling.

The first acquisition processing unit 112 acquires, for each tag tg, information (tag status information D1) indicating the presence/absence of the AGV and the presence/absence of the storage shelf T. In the present embodiment, a plurality of the tags tg are arranged, one for each storage position of the storage shelf T, and thus the first acquisition processing unit 112 acquires the tag status information D1 corresponding to each of the plurality of tags tg. For example, in the example illustrated in FIGS. 5 to 7, the first acquisition processing unit 112 acquires the presence/absence of the AGV and the presence/absence of the storage shelf T for each of the tags tg1 to tg20.

The second acquisition processing unit 113 acquires information (AGV status information D2) indicating the current position and the presence/absence of the storage shelf T (whether the storage shelf T is being transported) for each AGV. For example, in the example illustrated in FIGS. 5 to 7, the second acquisition processing unit 113 acquires the current position and the presence/absence of the storage shelf T for the AGV1 to the AGV3.

The determination processing unit 114 determines whether the AGV can travel to the positions corresponding to the tags tg on the basis of the tag status information D1 and the AGV status information D2. The determination processing unit 114 executes the determination processing for each AGV.

For example, the AGV1 is currently at the position of the tag tg6 (position information P1 in FIG. 7), and is transporting (loaded with) the storage shelf T5. In this case, with the storage shelf T5 being loaded, the AGV1 cannot move to a position of the tag tg where another storage shelf T is arranged. For example, the AGV1 cannot move to the position of the tag tg1 where the storage shelf T1 is arranged, the position of the tag tg2 where the storage shelf T2 is arranged, the position of the tag tg16 where the storage shelf T7 is arranged, or the like. On the other hand, the storage shelf T and the AGV are not present at the tags tg7 to tg9, tg11, tg12, and the like, and thus the AGV1 can move to these positions.

Further, the AGV2 is present at the position of the tag tg10, and thus the AGV1 cannot move to the position of the tag tg10 at the current time. However, when the AGV2 moves, the AGV1 can move to the position of the tag tg10. Similarly, the AGV3 transporting the storage shelf T6 is present at the position of the tag tg13, and thus the AGV1 cannot move to the position of the tag tg13 at the current time. However, when the AGV3 moves with the storage shelf T6 loaded thereon, the AGV1 can move to the position of the tag tg13.

Further, for example, the AGV2 is currently at the position of the tag tg10 (position information P2 in FIG. 7) and is not transporting (loaded with) the storage shelf T5. In this case, the AGV2 cannot move to a position of the tag tg where another AGV is present at the current time. For example, the AGV2 cannot move to the position of the tag tg6 where the AGV1 is present or to the position of the tag tg13 where the AGV3 is present at the current time. However, when the AGV1 moves, the AGV2 can move to the position of the tag tg6 and, when the AGV3 moves, the AGV2 can move to the position of the tag tg13.

On the other hand, at the tags tg4, tg5, tg19, tg20, and the like, the storage shelves T are present, but other AGVs are not present, allowing passage under the storage shelves T. Therefore, the AGV1 can move to these positions at the current time. Further, the storage shelves T and other AGVs are not present at the tags tg3, tg7 to tg9, tg14, tg15, and the like, and thus the AGV1 can move to these positions at the current time.

The AGV3 is currently at the position of the tag tg13 (position information P3 in FIG. 7) and is transporting (loaded with) the storage shelf T6, and thus the situation is the same as that of the AGV1.

The determination processing unit 114 determines whether the AGV1, the AGV2, and the AGV3 can travel through the positions corresponding to the tags tg on the basis of the current situation of each AGV. Specifically, on the basis of the tag status information D1 and the AGV status information D2, the determination processing unit 114 sets the tag tg of the storage area as a travelable tag through which the AGV can pass or a non-travelable tag through which the AGV cannot pass. Further, the determination processing unit 114 sets each tag tg as a travelable tag or a non-travelable tag for each AGV.

For example, for each AGV transporting the storage shelf T and each AGV not transporting the storage shelf T, when a storage shelf T is not arranged at the position corresponding to the tag tg and an AGV is not present at the position corresponding to the tag tg, the determination processing unit 114 sets that tag tg as a travelable tag. In the example illustrated in FIG. 5, the determination processing unit 114 sets the tags tg3, tg7 to tg9, tg11, tg12, tg14, tg15, tg18 as travelable tags for the AGV1, the AGV2, and the AGV3.

Further, for example, for each AGV transporting the storage shelf T and each AGV not transporting the storage shelf T, when a storage shelf T is not arranged at the position corresponding to the tag tg and an AGV is present at the position corresponding to the tag tg, the determination processing unit 114 sets that tag tg as a travelable tag. In the example illustrated in FIG. 5, the determination processing unit 114 sets the tag tg10 as a travelable tag for the AGV1, the AGV2, and the AGV3.

Further, for example, for each AGV not transporting the storage shelf T, when a storage shelf T is arranged at the position corresponding to the tag tg and an AGV is not present at the position corresponding to the tag tg and the AGV is not transporting the storage shelf T, the determination processing unit 114 sets that tag tg as a travelable tag. In the example illustrated in FIG. 5, the determination processing unit 114 sets the tags tg1, tg2, tg4, tg5, tg16, tg17, tg19, tg20 as travelable tags for the AGV2.

Further, for example, for each AGV transporting the storage shelf T, when a storage shelf Tis arranged at the position corresponding to the tag tg and an AGV is not present at the position corresponding to the tag tg and the AGV is transporting the storage shelf T, the determination processing unit 114 sets that tag tg as a non-travelable tag. In the example illustrated in FIG. 5, the determination processing unit 114 sets the tags tg1, tg2, tg4, tg5, tg16, tg17, tg19, tg20 as non-travelable tags for the AGV1 and the AGV3.

Further, for example, for each AGV transporting the storage shelf T and each AGV not transporting the storage shelf T, when a storage shelf T is arranged at the position corresponding to the tag tg and an AGV is present at the position corresponding to the tag tg, the determination processing unit 114 sets that tag tg as a travelable tag. In the example illustrated in FIG. 5, the determination processing unit 114 sets the tags tg6, tg13 as travelable tags for the AGV1, the AGV2, and the AGV3.

Thus, the determination processing unit 114 executes the processing (classification processing) of classifying each of the plurality of tags tg arranged in the storage area into the tag tg through which the AGV can travel or the tag tg through which the AGV cannot travel on the basis of whether the AGV subject to the determination is transporting the storage shelf T. The determination processing unit 114 executes the classification processing for each AGV while updating the status of each tag tg (tag status information D1) and the status of each AGV (AGV status information D2).

The generation processing unit 115 generates a travel route of the automatic traveling device 2 on the basis of the determination result of the determination processing unit 114. In the example described above, the generation processing unit 115 generates the travel routes of the AGV1, the AGV2, and the AGV3 on the basis of the determination results (classification results) corresponding to each AGV. Specifically, the generation processing unit 115 generates, for each AGV, a travel route that includes the travelable tags and does not include the non-travelable tags.

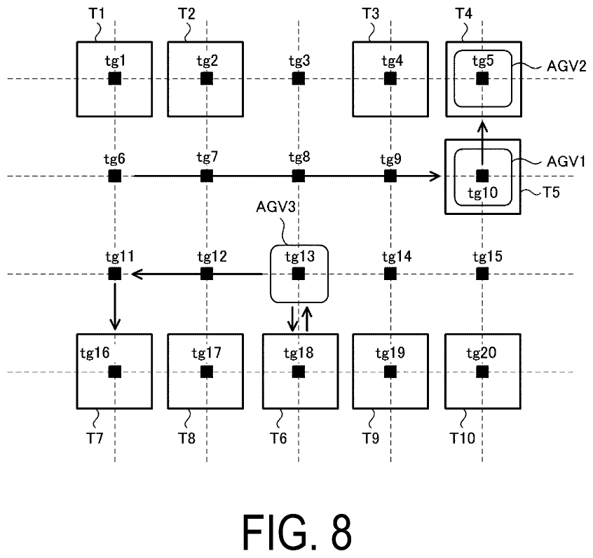

For example, as illustrated in FIG. 8, the generation processing unit 115 generates a travel route for moving from the tag g10 to the tag tg5 for the AGV2. Further, the generation processing unit 115 generates a travel route for moving from the tag tg6 to the tag tg10 for the AGV1. Here, the AGV2 positioned at the tag tg10 moves to the tag tg5 where the storage shelf T4 is positioned, and thus the determination processing unit 114 sets the tag tg10 as a travelable tag for the AGV1. This makes it possible for the generation processing unit 115 to generate a travel route to the tag tg10 for the AGV1.

Further, the generation processing unit 115 generates a travel route for moving from the tag tg13 to the tag tg18 and a travel route for moving from the tag tg18 to the tag tg16 for the AGV3. Here, the AGV3, upon transporting the storage shelf T6 to the position of the tag tg18 (refer to FIGS. 5 and 8), unloads the storage shelf T6 at the position of the tag tg18, then moves in the order of the tag tg13, the tag tg12, the tag tg11, and the tag tg16, and couples the storage shelf T7 arranged at the position of the tag tg16.

Thus, the generation processing unit 115 generates a travel route for each AGV. Further, the generation processing unit 115 generates the travel route for each AGV while updating the status of each tag tg (tag status information D1) and the status of each AGV (AGV status information D2).

The output processing unit 116 outputs travel instructions including the travel route information to each automatic traveling device 2. Specifically, the output processing unit 116 outputs the identification information of the plurality of tags tg corresponding to the travel route and the map data to each AGV.

Each AGV, upon acquiring the identification information of the tags tg corresponding to the travel route and the map data, travels along the travel route on the basis of the position coordinates corresponding to the tags tg included in the map data. Each AGV transmits the current position (position information) and information related to the presence/absence of the storage shelf T to the management server 1 in real time.

Note that the controller 11, for each AGV, generates a travel route on the basis of the set travelable tags and non-travelable tags, and outputs travel instructions on the basis of the positions of the other AGVs. Therefore, for example, when another AGV is present on the travel route generated for the AGV subject to travel control, the controller 11 outputs the travel instructions to the AGV subject to travel control after the other AGV moves.

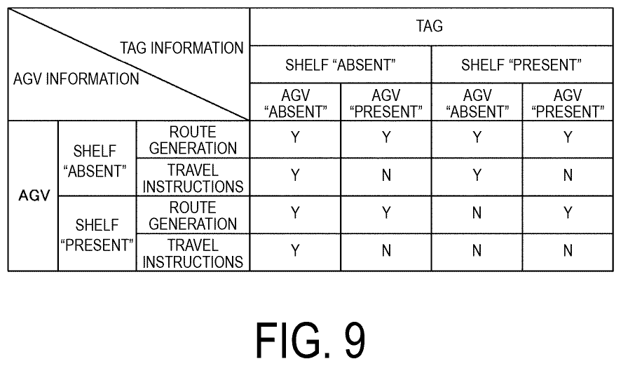

FIG. 9 shows a correspondence table in which the possibility of route generation and the possibility of travel instructions are classified according to whether the AGV is transporting the storage shelf T (presence/absence of shelf), whether a storage shelf T is present at the tag tg (presence/absence of shelf), and whether an AGV is present at the tag tg (presence/absence of AGV). For example, for an AGV not transporting a storage shelf T (shelf “absent”), a travel route including a tag tg where a storage shelf T is not present and another AGV is present (shelf “absent,” AGV “present”) can be generated (“Y”), but travel instructions cannot be issued (“N”). Further, for an AGV not transporting a storage shelf T (shelf “absent”), a travel route including a tag tg where another AGV transporting a storage shelf T is present (shelf “present,” AGV “present”) cannot be generated (“N”), and travel instructions cannot be issued (“N”).

Further, for an AGV transporting a storage shelf T (shelf “present”), a travel route including a tag tg where a storage shelf T is not present and another AGV is present (shelf “absent,” AGV “present”) cannot be generated (“N”), and travel instructions cannot be issued (“N”). Further, for an AGV transporting a storage shelf T (shelf “present”), a travel route including a tag tg where a storage shelf T is present and another AGV is not present (shelf “present,” AGV “absent”) cannot be generated (“N”), and travel instructions cannot be issued (“N”). Further, for an AGV transporting a storage shelf T (shelf “present”), a travel route including a tag tg where another AGV transporting a storage shelf T is present (shelf “present,” AGV “present”) can be generated (“Y”), but travel instructions cannot be issued (“N”).

### Traveling Processing

Hereinafter, the traveling processing executed in the traveling system 10 according to the present embodiment will be described with reference to FIG. 10. Specifically, in the present embodiment, the traveling processing is executed by the controller 11 of the management server 1. Further, the controller 11 can execute a plurality of operations of traveling processing in parallel in response to a plurality of shipping requests for the plurality of automatic traveling devices 2. The controller 11 starts execution of the traveling processing illustrated in FIG. 10 when the automatic traveling device 2 is caused to start the transport operation in response to a shipping request.

Note that the disclosure can be regarded as the disclosure of a traveling method that executes one or more steps included in the traveling processing. Further, one or more steps included in the traveling processing described herein may be omitted as appropriate. Note that each of the steps in the traveling processing may be executed in a different order within a range in which the same effect is obtained. Furthermore, here, a case in which the controller 11 executes each of the steps in the traveling processing will be described as an example, but a traveling method in which one or more processors execute each of the steps in the traveling processing in a distributed manner is also conceivable as another embodiment.

First, in step S1, the controller 11 acquires information (tag status information D1) indicating the presence/absence of the AGV and the presence/absence of the storage shelf T for each tag tg. For example, in the example illustrated in FIGS. 5 to 7, the controller 11 acquires the presence/absence of the AGV and the presence/absence of the storage shelf T for each of the tags tg1 to tg20.

Next, in step S2, the controller 11 acquires information (AGV status information D2) indicating the current position and the presence/absence of the storage shelf T (whether the storage shelf T is being transported) for each AGV. For example, in the example illustrated in FIGS. 5 to 7, the controller 11 acquires the current positions and the presence/absence of the storage shelf T for the AGV1 to the AGV3.

Next, in step S3, the controller 11 determines whether each AGV can travel through the positions corresponding to the tags tg on the basis of the tag status information D1 and the AGV status information D2. Specifically, on the basis of the tag status information D1 and the AGV status information D2, the controller 11 sets each tag tg of the storage area as a travelable tag through which the AGV can pass or a non-travelable tag through which the AGV cannot pass. The controller 11 sets each tag tg as a travelable tag or a non-travelable tag for each AGV.

That is, the controller 11 executes the processing (classification processing) for classifying each of the plurality of tags tg arranged in the storage area into a tag tg through which the AGV can travel or a tag tg through which the AGV cannot travel on the basis of whether the AGV subject to the determination is transporting the storage shelf T. The controller 11 executes the classification processing for each AGV while updating the status of each tag tg (tag status information D1) and the status of each AGV (AGV status information D2).

Next, in step S4, the controller 11 generates a travel route for the automatic traveling device 2 on the basis of the determination result (classification result) of the determination processing unit 114. For example, the controller 11 generates, for each AGV, a travel route that includes the travelable tags and does not include the non-travelable tags on the basis of the determination result (classification result) corresponding to each of the AGV1, the AGV2, and the AGV3. The controller 11 generates the travel route for each AGV while updating the status of each tag tg (tag status information D1) and the status of each AGV (AGV status information D2).

Next, in step S5, the controller 11 outputs travel instructions including the travel route information to each automatic traveling device 2. Specifically, the controller 11 outputs the identification information of the plurality of tags tg corresponding to the travel route and the map data to each AGV.

Each AGV, upon acquiring the identification information of the tag tg corresponding to the travel route and the map data, travels along the travel route on the basis of the position coordinates corresponding to the tags tg included in the map data. Each AGV transmits the current position (position information) and information related to the presence/absence of the storage shelf T to the management server 1 in real time.

Next, in step S6, the controller 11 determines whether each automatic traveling device 2 has ended traveling on the travel route. For example, the controller 11 determines that the traveling has ended when each AGV ends the traveling processing according to the shipping request. When each AGV ends traveling on the travel route, the controller 11 ends the traveling processing (S6: Yes).

The controller 11 repeats the processing of steps S1 to S5 until each AGV ends traveling on the travel route (S6: No). For example, the controller 11, while the AGV1 is traveling on the travel route, repeatedly executes the processing of generating the next travel route with an end position of the travel route as a start position of the next travel route; while the AGV2 is traveling on the travel route, repeatedly executes the processing of generating the next travel route with an end position of the travel route as a start position of the next travel route; and, while the AGV3 is traveling on the travel route, repeatedly executes the processing of generating the next travel route with an end position of the travel route as a start position of the next travel route. The controller 11 repeatedly executes the above processing for each AGV until each AGV reaches a target position. A travel route is generated for each AGV every time the AGV receives the identification information of the tags tg and the map data from the management server 1.

As described above, the traveling system 10 according to the present embodiment is a system that controls the traveling of the automatic traveling device 2 that travels while sequentially detecting the plurality of tags tg arranged on the floor surface and is capable of transporting, to a designated position (picking area), the transport target (storage shelf T) stored at the position corresponding to part (storage position designation tag) of the plurality of tags. The traveling system 10 acquires the tag status information D1 (refer to FIG. 6) including information indicating whether the storage shelf T is present at the position corresponding to the tag tg and information indicating whether the automatic traveling device 2 is present at the position corresponding to the tag tg, and acquires the AGV status information D2 indicating whether the automatic traveling device 2 is transporting the storage shelf T. The traveling system 10 determines whether the automatic traveling device 2 is capable of traveling through the position corresponding to the tag tg on the basis of the tag status information D1 and the AGV status information D2, and generates a travel route of the automatic traveling device 2 on the basis of the determination result.

According to the above-described configuration, a region (storage area) in which the plurality of storage shelves T are arranged can be effectively utilized as a travel route of the automatic traveling device 2. For example, in the example illustrated in FIG. 5, the AGV2 that is not transporting the storage shelf T can move to a position of a storage shelf T where another AGV is not present or pass under the storage shelf T. Further, for each AGV, when an AGV is present at a position of a storage shelf T, the AGV can move to the position of the storage shelf T when that AGV moves together with the storage shelf T. As described above, it is possible to improve the traveling efficiency of the automatic traveling device 2 capable of transporting a transport target (storage shelf T).

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

A traveling system that controls traveling of an automatic traveling device that travels while sequentially detecting a plurality of tags arranged on a floor surface and is capable of transporting, to a designated position, a transport target stored at a position corresponding to a storage position designation tag that is part of the plurality of tags, the traveling system including:
a first acquisition processing circuit that acquires storage position designation tag status information including
   information indicating whether the transport target is present at the position corresponding to the storage position designation tag and
   information indicating whether the automatic traveling device is present at the position corresponding to the storage position designation tag;
a second acquisition processing circuit that acquires automatic traveling device status information indicating whether the automatic traveling device is transporting the transport target;
a determination processing circuit that determines whether the automatic traveling device is capable of traveling through the position corresponding to the storage position designation tag on the basis of the storage position designation tag status information and the automatic traveling device status information; and
a generation processing circuit that generates a travel route of the automatic traveling device on the basis of a determination result of the determination processing circuit.

### Supplementary Note 2

The traveling system according to supplementary note 1, further including:
a registration processing circuit that registers the storage position designation tag status information in association with identification information of the tag, and registers the automatic traveling device status information in association with identification information of the automatic traveling device.

### Supplementary Note 3

The traveling system according to supplementary note 1 or 2,
wherein a plurality of the storage position designation tags are arranged, one for each storage position of the transport target, and
the first acquisition processing circuit acquires the storage position designation tag status information corresponding to each of the plurality of storage position designation tags.

### Supplementary Note 4

The traveling system according to any one of supplementary notes 1 to 3,
wherein the determination processing circuit sets the storage position designation tag as a travelable tag through which the automatic traveling device can pass or as a non-travelable tag through which the automatic traveling device cannot pass, on the basis of the automatic traveling device status information and the storage position designation tag status information, and
the generation processing circuit generates the travel route including the travelable tag and not including the non-travelable tag.

### Supplementary Note 5

The traveling system according to supplementary note 4,
wherein, when the transport target is not arranged at the position corresponding to the storage position designation tag and the automatic traveling device is not present at the position corresponding to the storage position designation tag, the determination processing circuit sets the storage position designation tag as the travelable tag.

### Supplementary Note 6

The traveling system according to supplementary note 4 or 5,
wherein, when the transport target is not arranged at the position corresponding to the storage position designation tag and the automatic traveling device is present at the position corresponding to the storage position designation tag, the determination processing circuit sets the storage position designation tag as the travelable tag.

### Supplementary Note 7

The traveling system according to any one of supplementary notes 4 to 6,
wherein, when the transport target is arranged at the position corresponding to the storage position designation tag and the automatic traveling device is not present at the position corresponding to the storage position designation tag and the automatic traveling device is not transporting the transport target, the determination processing circuit sets the storage position designation tag as the travelable tag.

### Supplementary Note 8

The traveling system according to any one of supplementary notes 4 to 7,
wherein, when the transport target is arranged at the position corresponding to the storage position designation tag and the automatic traveling device is not present at the position corresponding to the storage position designation tag and the automatic traveling device is transporting the transport target, the determination processing circuit sets the storage position designation tag as the non-travelable tag.

### Supplementary Note 9

The traveling system according to any one of supplementary notes 4 to 8,
wherein, when the transport target is arranged at the position corresponding to the storage position designation tag and the automatic traveling device is present at the position corresponding to the storage position designation tag, the determination processing circuit sets the storage position designation tag as the travelable tag.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A traveling system comprising:
one or more processors that control traveling of an automatic traveling device that travels while sequentially detecting a plurality of tags arranged on a floor surface and is capable of transporting, to a designated position, a transport target stored at a position corresponding to a storage position designation tag that is part of the plurality of tags,
wherein the one or more processors
acquire storage position designation tag status information including
information indicating whether the transport target is present at the position corresponding to the storage position designation tag, and
information indicating whether the automatic traveling device is present at the position corresponding to the storage position designation tag,
acquire automatic traveling device status information indicating whether the automatic traveling device is transporting the transport target,
determine whether the automatic traveling device is capable of traveling through the position corresponding to the storage position designation tag on the basis of the storage position designation tag status information and the automatic traveling device status information, and
generate a travel route of the automatic traveling device on the basis of a determination result.

2. The traveling system according to claim 1,
wherein the one or more processors
register the storage position designation tag status information in association with identification information of the tag, and
register the automatic traveling device status information in association with identification information of the automatic traveling device.

3. The traveling system according to claim 1,
wherein a plurality of the storage position designation tags are arranged, one for each storage position of the transport target, and
the one or more processors acquire the storage position designation tag status information corresponding to each of the plurality of storage position designation tags.

4. The traveling system according to claim 1,
wherein the one or more processors
set the storage position designation tag as a travelable tag through which the automatic traveling device can pass or as a non-travelable tag through which the automatic traveling device cannot pass, on the basis of the automatic traveling device status information and the storage position designation tag status information, and
generate the travel route including the travelable tag and not including the non-travelable tag.

5. The traveling system according to claim 4,
wherein, when the transport target is not arranged at the position corresponding to the storage position designation tag and the automatic traveling device is not present at the position corresponding to the storage position designation tag, the one or more processors set the storage position designation tag as the travelable tag.

6. The traveling system according to claim 4,
wherein, when the transport target is not arranged at the position corresponding to the storage position designation tag and the automatic traveling device is present at the position corresponding to the storage position designation tag, the one or more processors set the storage position designation tag as the travelable tag.

7. The traveling system according to claim 4,
wherein, when the transport target is arranged at the position corresponding to the storage position designation tag and the automatic traveling device is not present at the position corresponding to the storage position designation tag and the automatic traveling device is not transporting the transport target, the one or more processors set the storage position designation tag as the travelable tag.

8. The traveling system according to claim 4,
wherein, when the transport target is arranged at the position corresponding to the storage position designation tag and the automatic traveling device is not present at the position corresponding to the storage position designation tag and the automatic traveling device is transporting the transport target, the one or more processors set the storage position designation tag as the non-travelable tag.

9. The traveling system according to claim 4,
wherein, when the transport target is arranged at the position corresponding to the storage position designation tag and the automatic traveling device is present at the position corresponding to the storage position designation tag, the one or more processors set the storage position designation tag as the travelable tag.

10. A traveling method for controlling traveling of an automatic traveling device that travels while sequentially detecting a plurality of tags arranged on a floor surface and is capable of transporting, to a designated position, a transport target stored at a position corresponding to a storage position designation tag that is part of the plurality of tags, the traveling method comprising:
acquiring storage position designation tag status information including
information indicating whether the transport target is present at the position corresponding to the storage position designation tag, and
information indicating whether the automatic traveling device is present at the position corresponding to the storage position designation tag;
acquiring automatic traveling device status information indicating whether the automatic traveling device is transporting the transport target;
determining whether the automatic traveling device is capable of traveling through the position corresponding to the storage position designation tag on the basis of the storage position designation tag status information and the automatic traveling device status information; and
generating a travel route of the automatic traveling device on the basis of a determination result.

11. A non-transitory computer-readable recording medium storing a traveling program that controls traveling of an automatic traveling device that travels while sequentially detecting a plurality of tags arranged on a floor surface and is capable of transporting, to a designated position, a transport target stored at a position corresponding to a storage position designation tag that is part of the plurality of tags,
the traveling program causing one or more processors to execute:
acquiring storage position designation tag status information including
information indicating whether the transport target is present at the position corresponding to the storage position designation tag, and
information indicating whether the automatic traveling device is present at the position corresponding to the storage position designation tag,
acquiring automatic traveling device status information indicating whether the automatic traveling device is transporting the transport target,
determining whether the automatic traveling device is capable of traveling through the position corresponding to the storage position designation tag on the basis of the storage position designation tag status information and the automatic traveling device status information, and
generating a travel route of the automatic traveling device on the basis of a determination result.
